(19) United States
(12) Patent Application Publication
(10) Pub. No.: US 2012/0039192 A1
(43) Pub. Date: Feb. 16, 2012

(54) INTERFERENCE CANCELLATION

(75) Inventors: Ying Peng, Beijing (CN); Simon Armour, Bath (GB); Joe McGeehan, Wiltshire (GB); Tomoyoshi Yokota, Kanagawa (JP); Fangwei Tong, Kanagawa (JP)

(73) Assignees: THE UNIVERSITY OF BRISTOL, Bristol (GB); KYOCERA CORPORATION, Kyoto (JP)

(21) Appl. No.: 13/146,846

(22) PCT Filed: Jan. 28, 2009
(86) PCT No.: PCT/JP2009/051828

§ 371 Date: Nov. 6, 2011

(51) Int. Cl. H04J 1/12

(52) U.S. Cl. 370/252

(57) ABSTRACT

There is provided a first device for use in a communication system, the communication system further comprising a plurality of second devices, the system having a plurality of orthogonal frequency carriers available for transmissions, each second device having a respective carrier frequency offset estimated from signals received from the first device, each of the second devices transmitting a respective stream of symbols using the respective estimated carrier frequency offset and one or more frequency carriers selected from the plurality of orthogonal frequency carriers, the first device comprising receiver circuitry for receiving respective signals from each of the second devices; a channel estimator for generating, from the received signals, an estimate of the channel over which the signals have been transmitted; an interference estimator for generating, from the received signals, an estimate of interference at the first device caused by errors in the carrier frequency offsets estimated by each second device; and circuitry for equalising the received signals using the estimate of the channel and the estimate of the interference.

### TECHNICAL FIELD

The invention relates to methods and apparatus for use in the cancellation of carrier frequency offset interference in communication systems, and in particular the cancellation of carrier frequency offset interference in orthogonal frequency division multiple access (OFDMA) communication systems, spatial division multiple access (SDMA) OFDMA communication systems and multiple-input multiple-output (MIMO) OFDMA communication systems.

### BACKGROUND ART

In orthogonal frequency division multiplex (OFDM) systems, a number of orthogonal frequency carriers are used to carry respective streams of data. It is necessary for the frequencies used for the carriers to be synchronised in the transmitter and receiver, otherwise a frequency deviation will exist between the carriers, causing a loss of orthogonality and therefore inter-carrier interference. Synchronisation issues can arise from the oscillators in the transmitter and receiver being mismatched, or a Doppler shift caused by the movement of one or both of the transmitter and receiver.

To prevent the loss of orthogonality, it is necessary for the receiver to estimate the amount by which the frequency carriers used to transmit the signals are offset from the desired carriers, and to apply this carrier frequency offset (CFO) to the received signals.

Typically, a predefined sequence of symbols is transmitted in order to facilitate CFO estimation. Various methods are known, often based on some form of autocorrelation process. Any CFO estimation algorithm will be vulnerable to errors arising from distortion of the sequence by the communication channel.

Any errors in the estimation of the carrier frequency offset in a downlink direction (for example from a base station to a mobile station) will result in residual synchronisation errors in the uplink direction. These residual errors cause carrier frequency offset interference (CFOI), i.e. interference (loss of orthogonality) that results from errors in the CFO estimation.

A similar requirement to correct carrier frequency offset exists in orthogonal frequency division multiple access (OFDMA) systems, in which users are assigned a subset of the available carriers.

As above, in addition to correcting the frequency offset for a downlink from a base station to a mobile station (for example), it is necessary to correct the frequency offset in the uplink. In this case, however, the frequency deviation for each user in the uplink will be different, so the correction of the frequency of one user cannot be accomplished individually in the base station, since if the offset is corrected for one user, it misaligns the other users.

The situation is further complicated in the uplink direction of a spatial division multiple access OFDMA (SDMA-OFDMA) system, for example as shown in FIG. 1. Each mobile station/user 2 has a respective oscillator and pair of antennas, which means where mobile stations 2 share one or more frequency carriers for transmitting data to the base station 4, there can be a different carrier frequency offset for each mobile station 2 using the carrier. Therefore, it is not possible to apply a single CFO to the signals received on each carrier.

The CFOI caused by the residual CFO from the downlink direction will include self-interference, interference on the shared carriers from the other mobile station(s) 2 using that carrier and interference from other mobile station(s) 2 using different carriers.

One known solution to this problem is described in “Frequency Offset Compensation Scheme Using Interference Cancellation in Reverse Link of OFDM/SDMA systems” by Naoto Egashira, Takahiko Saba, IEICE TRANS, Fundamentals, Vol. E89-A, No. 10 October 2006 which proposes a frequency offset compensation scheme without feedback transmission by adapting the principle of parallel interference cancellation (PIC) and iteration of the cancellation and replica generation process after equalisation.

However the combination of PIC and iteration increases the computational complexity enormously.

Therefore, it is desirable to provide an alternative way of cancelling the carrier frequency offset interference, that does not substantially increase the computational complexity, and that is simple to implement in a receiver.

### DISCLOSURE OF INVENTION

A first aspect of the invention provides a first device for use in a communication system, the communication system further comprising a plurality of second devices, the system having a plurality of orthogonal frequency carriers available for transmissions, each second device having a respective carrier frequency offset estimated from signals received from the first device, each of the second devices transmitting a respective stream of symbols using the respective estimated carrier frequency offset and one or more frequency carriers selected from the plurality of orthogonal frequency carriers, the first device comprising receiver circuitry for receiving respective signals from each of the second devices; a channel estimator for generating, from the received signals, an estimate of the channel over which the signals have been transmitted; an interference estimator for generating, from the received signals, an estimate of interference at the first device caused by errors in the carrier frequency offsets estimated by each second device; and circuitry for equalising the received signals using the estimate of the channel and the estimate of the interference.

According to a second aspect of the invention, there is provided a method for operating a first device in a communication system, the system further comprising a plurality of second devices, the system having a plurality of orthogonal frequency carriers available for transmissions, each second device having a respective carrier frequency offset estimated from signals received from the first device, each of the second devices transmitting a respective stream of symbols using the respective estimated carrier frequency offset and one or more frequency carriers selected from the plurality of orthogonal frequency carriers, the method in the first device comprising receiving respective signals from each of the second devices; generating, from the received signals, an estimate of the channel over which the signals have been transmitted; generating, from the received signals, an estimate of interference at the first device caused by errors in the carrier frequency offsets estimated by each second device; and equalising the received signals using the estimate of the channel and the estimate of the interference.

### BRIEF DESCRIPTION OF THE DRAWINGS

FIG. 1 shows an exemplary SDMA-OFDMA system;

FIG. 2 is a block diagram of a first device in accordance with a first embodiment of the invention;

FIG. 3 is a flow chart illustrating the steps in a method in accordance with the first embodiment of the invention;

FIG. 4 is a block diagram of a first device in accordance with a second embodiment of the invention;

FIG. 5 is a flow chart illustrating the steps in a method in accordance with the second embodiment of the invention; and

FIG. 6 is a graph illustrating the performance of the first devices of FIGS. 2 and 4 over conventional devices.

### BEST MODE FOR CARRYING OUT THE INVENTION

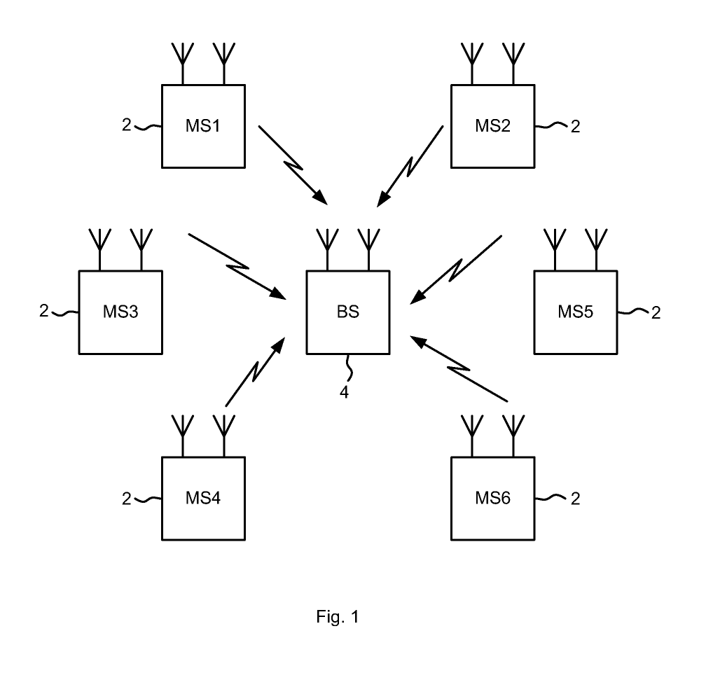

The invention is concerned with the receipt of signals in an OFDMA communication system that is using SDMA as described above with reference to FIG. 1, or MIMO.

The problem solved by the invention is illustrated in more detail below.

Consider six users (MS1, MS2, MS3, MS4, MS5, MS6 in FIG. 1) 2 each transmitting data to the base station 4, with the users 2 being paired (e.g. MS1 and MS2, MS3 and MS4, MS5 and MS6) such that each user 2 in a pair uses the same bandwidth (carriers). The users 2 are divided into two groups, group 1 comprising MS1, MS3 and MS5 and group 2 comprising MS2, MS4 and MS6, so there is no overlap in the carriers used within a group.

An interference matrix Π is constructed for each group which includes the estimates of the frequency offsets for each of the users 2 in that group. The interference matrix Π is given by:

$$Π = {\sum }_{u}^{{N}_{u}} {F}^{H} {E}^{u} F \qquad ( 1 )$$

where F is an inverse Discrete Fourier Transform matrix of dimension N×V (where N is the number of users and V is the number of sub-carriers for each user) and E defines the distortive effect of the carrier frequency offset on the signal of a particular user in the time domain.

The output of each antenna in the receiver in the base station 4 is given by

Gᵣ₁=Π₁S₁₁+Π₂S₂₁ (2)

Gᵣ₂=Π₁S₁₂+Π₂S₂₂ (3)

where Gᵣ₁ and Gᵣ₂ denote the outputs from the first and second antennas respectively, Π₁ and Π₂ denote the interference matrices for group 1 and group 2 respectively, and S_{xy} denotes the signal received at antenna y from antenna x in the absence of carrier frequency offset. “x” can also be used to index the two users sharing subcarriers in a SDMA-OFDMA system.

It can be seen that the interference matrices of the two groups are not the same, so it is not possible to cancel the multiuser access interference jointly for both groups at the same time.

It is desirable for the signals of the two groups to be split by demultiplexing and equalisation. However, if there is a residual frequency offset, it is not possible to make the equalisation accurate, and in turn the separated CFOI cancellation processes for the two groups cannot be achieved.

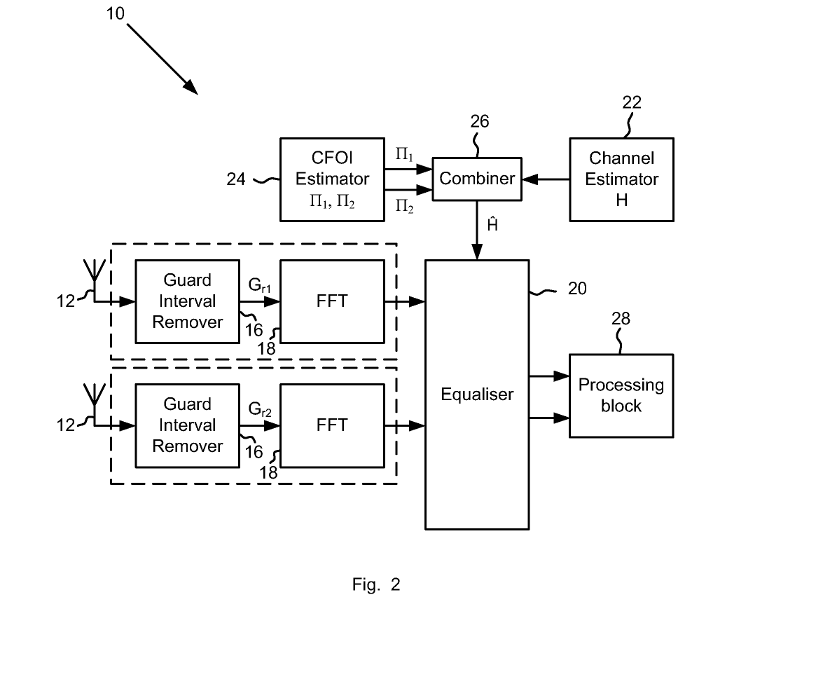

FIG. 2 shows an exemplary device 10 in accordance with a first embodiment of the invention. In this embodiment, there are two groups of users 2 transmitting signals to the device 10, as described above with reference to FIG. 1. Although the invention is shown as a device for receiving signals, it will be appreciated that the device can also be adapted to transmit signals.

The device 10 comprises two antennas 12 that each receives signals over an air interface. The signals received by each antenna 12 are processed by a respective guard interval remover 16 for removing the guard interval or cyclic prefix in the received signals to give a signal Gᵣₘ, (where m identifies the antenna) and a respective FFT block 18 for performing a fast Fourier transform on the signal Gᵣₘ.

It will be appreciated that the receiver front end comprising the antennas 12, guard interval removers 16 and FFT blocks 18 are well known in the art, and will not be described further herein. Moreover, it will be appreciated that the receiver front-end of the device 10 can be implemented in an alternative form to that illustrated.

The output of the FFT block 18 for each antenna 12 is provided to an equaliser 20.

A channel estimator 22 is provided that generates a matrix H representing the effect of the channel on the signals transmitted from the users/transmitters 2. Although not shown in FIG. 2, the channel estimator 22 receives copies of the signals received by each of the antennas 12 (with or without the guard interval). The output of the channel estimator 22 is the matrix H. Methods for determining the channel estimate matrix H are conventional, for example making use of a predefined sequence in the transmitted signals, and will not be described further herein.

In this embodiment of the invention, the cancellation or compensation of the carrier frequency offset interference (CFOI) is performed during equalisation. In particular, it is considered that the effect of the CFOI is part of the channel response.

Thus, the receiver architecture 10 comprises a carrier frequency offset estimator 24 that generates a matrix Π for each group of users that estimates the effect of the carrier frequency offset interference in the received signals for each of the users 2 in that group. Although not shown in FIG. 2, the carrier frequency offset estimator 24 receives copies of the signals received by each of the antennas 12 (with or without the guard interval). As with the channel estimate matrix H, the interference matrices Π can be determined by making use of predefined sequences in the transmitted signals. Again, methods for determining these matrices will be known to a person skilled in the art, and will not be described further herein.

A combiner 26 combines the CFOI estimate matrices Π₁ and Π₂ and the channel estimate matrix H to give a matrix Ĥ

$$\hat{H} = [ \begin{matrix}{Π}_{1} {H}_{11}^{u} & {Π}_{2} {H}_{21}^{u} \\ {Π}_{1} {H}_{12}^{u} & {Π}_{2} {H}_{22}^{u}\end{matrix} ] \\ \hat{H} = [ \begin{matrix}{\sum }_{u = 1 , 3 , 5} {F}^{H} {E}_{1}^{u} {FH}_{11}^{u} & {\sum }_{u = 2 , 4 , 6} {F}^{H} {E}_{2}^{u} {FH}_{21}^{u} \\ {\sum }_{u = 1 , 3 , 5} {F}^{H} {E}_{1}^{u} {FH}_{12}^{u} & {\sum }_{u = 2 , 4 , 6} {F}^{H} {E}_{2}^{u} {FH}_{22}^{u}\end{matrix} ] \qquad ( 4 )$$

which is provided to the equaliser 20.

The equaliser 20 processes the signals from each FFT block 18 with Ĥ to give streams of output symbols for each antenna 12 which are provided to a processing block 28 for further processing. The processing block 28 is conventional, and its operation will not be described further herein.

In a MMSE detection algorithm, the operation of the equaliser 20 can be represented by:

$$[ \frac{{\tilde{X}}_{1} ( k )}{{\tilde{X}}_{2} ( k )} ] = ( {\hat{H} ( k )}^{H} \hat{H} ( k ) + \frac{{n}_{T}}{SNR} {I}_{{n}_{T}} ) \hat{H} ( k ) [ \frac{{G}_{r 1} ( k )}{{G}_{r 2} ( k )} ] \qquad ( 5 )$$

where \tilde{X}₁(k) is the estimated transmitted signal from one of the users 2 of group 1 over a carrier k and \tilde{X}₂(k) is the estimated transmitted signal from the corresponding user 2 in group 2 that is using the same carrier k, n_{T} is the number of transmit antennas and SNR is a signal-to-noise ratio.

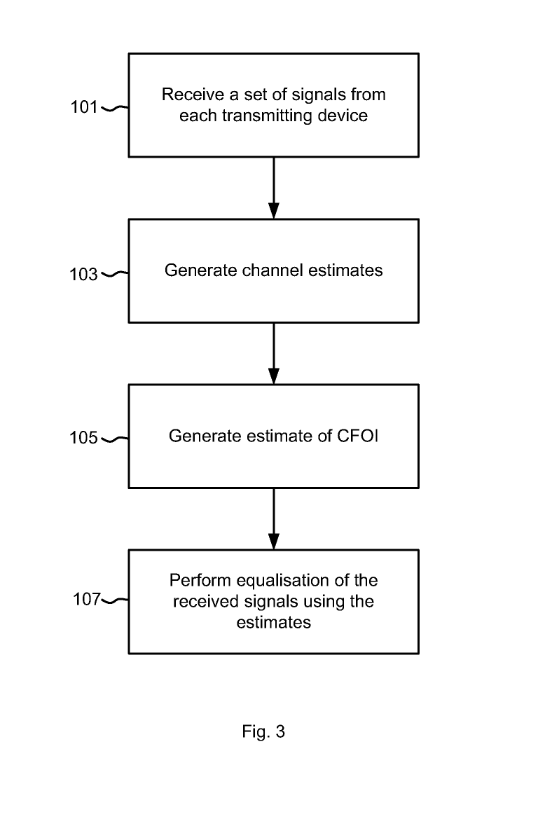

A method of receiving a data transmission in accordance with the invention is shown in FIG. 3. In step 101, the first (receiving) device 10 receives a respective set of signals from each of the second (transmitting) devices 2. Each of the signals has been transmitted from the second devices 2 using a carrier frequency offset determined from signals previously received from the first device 2 and a frequency carrier selected from a set of frequency carriers (which are orthogonal).

The first device 10 generates an estimate of the channels over which the signals have been transmitted (step 103).

As discussed above, there will be interference between the transmissions from the second devices 2 caused by errors in the estimation of the frequency offset in the opposite link (i.e. from the first device 10 to the second devices 2). Therefore, the first device 10 generates an estimate of the interference in the received signals caused by errors in the carrier frequency offsets estimated by each second device 2 (step 105).

In step 107, the first device equalises the received signals using the determined estimates to generate an output stream of data symbols.

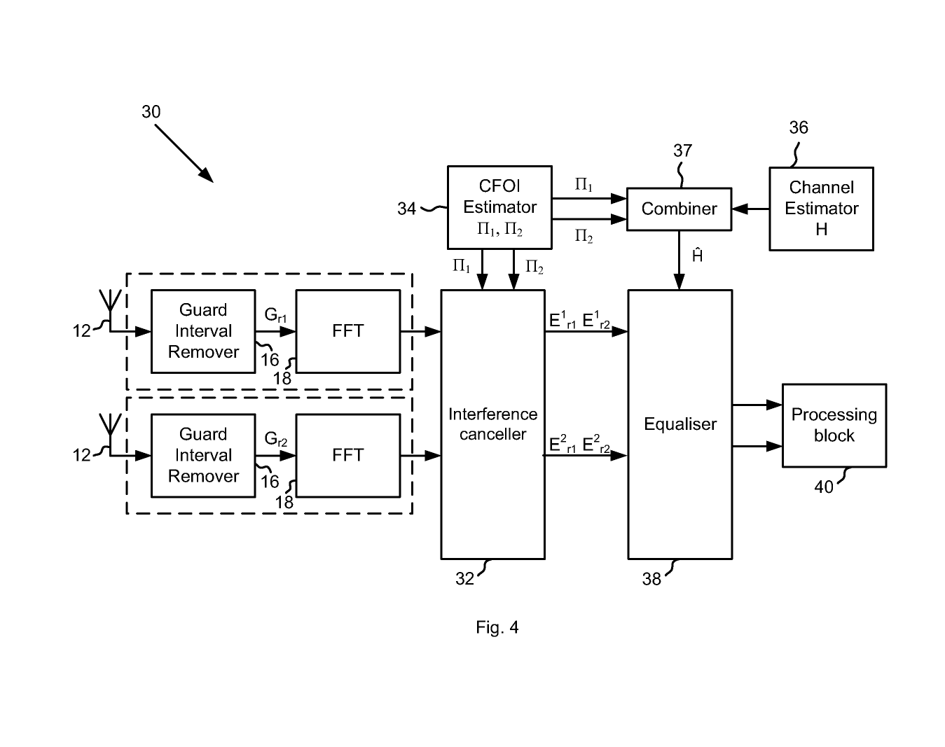

FIG. 4 shows an exemplary device 30 in accordance with a second embodiment of the invention. In this embodiment, there are two groups of users 2 transmitting signals to the device 30 as shown in FIG. 1. Again, although the invention is shown as a device for receiving signals, it will be appreciated that the device 30 can also be adapted to transmit signals.

In this embodiment, the cancellation or compensation of the carrier frequency offset interference (CFOI) is performed in two steps. In the first step, the CFOI for devices within each of the groups (referred to as intra-group interference) is cancelled in parallel, and in the second step, the remaining interference from errors in the carrier frequency offset is performed jointly with equalisation.

The device 30 comprises two antennas 12, guard interval removers 16 and FFT blocks 18 as described above with reference to FIG. 1.

In this embodiment, the output of each FFT block 18 is provided to a block 32 that cancels the interference (CFOI) within each of the groups caused by errors in the carrier frequency offsets of the second devices 2. According to this embodiment, the cancellation for each group is performed in parallel. In alternative embodiments, the cancellation can be performed for one of the groups, followed by the cancellation for the other group.

The device 30 is provided with a CFOI estimator 34 as described above with reference to the first embodiment. In this embodiment, the CFOI estimator 34 generates two interference matrices Π₁ and Π₂, one for each group of users, and provides these matrices to block 32. Although not shown in FIG. 4, the CFOI estimator 34 receives copies of the signals received by each of the antennas 12 (with or without the guard interval).

The interference canceller 32 has two parallel processing branches, with each processing branch cancelling the interference for one of the two groups. The MMSE partial interference cancellation in block 32 is given by:

Parallel processing branch 1 (cancellation of the interference in group 1):

$$\begin{matrix}{E}_{r 1}^{1} = {{Π}_{1}^{H} ( {Π}_{1} {Π}_{1}^{H} + \frac{1}{SNR} I )}^{- 1} {G}_{r 1} = {{Π}_{1}^{H} ( {Π}_{1} {Π}_{1}^{H} + \frac{1}{SNR} I )}^{- 1} {Π}_{1} {S}_{11} + {{Π}_{1}^{H} ( {Π}_{1} {Π}_{1}^{H} + \frac{1}{SNR} I )}^{- 1} {Π}_{2} {S}_{21} & ( 6 ) \\ {E}_{r 2}^{1} = {{Π}_{1}^{H} ( {Π}_{1} {Π}_{1}^{H} + \frac{1}{SNR} I )}^{- 1} {G}_{r 2} = {{Π}_{1}^{H} ( {Π}_{1} {Π}_{1}^{H} + \frac{1}{SNR} I )}^{- 1} {Π}_{1} {S}_{12} + {{Π}_{1}^{H} ( {Π}_{1} {Π}_{1}^{H} + \frac{1}{SNR} I )}^{- 1} {Π}_{2} {S}_{22} & ( 7 )\end{matrix}$$

Parallel processing branch 2 (cancellation of the interference in group 2):

$$\begin{matrix}{E}_{r 1}^{2} = {{Π}_{2}^{H} ( {Π}_{2} {Π}_{2}^{H} + \frac{1}{SNR} I )}^{- 1} {G}_{r 1} = {{Π}_{2}^{H} ( {Π}_{2} {Π}_{2}^{H} + \frac{1}{SNR} I )}^{- 1} {Π}_{1} {S}_{11} + {{Π}_{2}^{H} ( {Π}_{2} {Π}_{2}^{H} + \frac{1}{SNR} I )}^{- 1} {Π}_{2} {S}_{21} & ( 8 ) \\ {E}_{r 2}^{2} = {{Π}_{2}^{H} ( {Π}_{2} {Π}_{2}^{H} + \frac{1}{SNR} I )}^{- 1} {G}_{r 2} = {{Π}_{2}^{H} ( {Π}_{2} {Π}_{2}^{H} + \frac{1}{SNR} I )}^{- 1} {Π}_{1} {S}_{12} + {{Π}_{2}^{H} ( {Π}_{2} {Π}_{2}^{H} + \frac{1}{SNR} I )}^{- 1} {Π}_{2} {S}_{22} & ( 9 )\end{matrix}$$

where Eᵣₘⁿ are vectors after partial interference cancellation for either the first group of users or the second group of users by

$${( {Π}_{1} {Π}_{1}^{H} + \frac{1}{SNR} I )}^{- 1} or {( {Π}_{2} {Π}_{2}^{H} + \frac{1}{SNR} I )}^{- 1}$$

respectively, m is the receive antenna index and n is the index of parallel branches 14.

As in the first embodiment, a channel estimator 36 is provided to generate a matrix H representing the effect of the channel on the signals transmitted from the second devices 2. Although not shown in FIG. 4, the channel estimator 36 receives copies of the signals received by each of the antennas 12 (with or without the guard interval). The output of the channel estimator 36 is the matrix H, and this matrix is provided to a combiner 37.

The combiner 37 also receives the interference matrices Π₁ and Π₂ from the CFOI estimator 34 and combines them with the channel estimate matrix H to give Ĥ for each of the parallel processing branches as shown below:

For parallel branch 1:

$$\hat{H} = [ \begin{matrix}{H}_{11} & {{Π}_{1}^{H} ( {Π}_{1} {Π}_{1}^{H} + \frac{1}{SNR} I )}^{- 1} {Π}_{2} {H}_{21} \\ {H}_{12} & {{Π}_{1}^{H} ( {Π}_{1} {Π}_{1}^{H} + \frac{1}{SNR} I )}^{- 1} {Π}_{2} {H}_{22}\end{matrix} ] \qquad ( 10 )$$

For parallel branch 2:

$$\hat{H} = [ \begin{matrix}{{Π}_{2}^{H} ( {Π}_{2} {Π}_{2}^{H} + \frac{1}{SNR} I )}^{- 1} {H}_{11} & {H}_{21} \\ {{Π}_{2}^{H} ( {Π}_{2} {Π}_{2}^{H} + \frac{1}{SNR} I )}^{- 1} {H}_{12} & {H}_{22}\end{matrix} ] \qquad ( 11 )$$

The outputs of the combiner 37 and intra-group interference cancellation block 32 are provided to the equaliser 38.

The equaliser 38 multiplies the signals Eᵣₘⁿ from each parallel processing branch by Ĥ, as defined above, to equalise the signals and to remove the residual CFOI.

As in the first embodiment, in a MMSE detection algorithm, the operation of the equaliser 38, for each parallel processing branch, can be represented by:

$$[ \frac{{\tilde{X}}_{1} ( k )}{{\tilde{X}}_{2} ( k )} ] = ( {\hat{H} ( k )}^{H} \hat{H} ( k ) + \frac{{n}_{T}}{SNR} {I}_{{n}_{T}} ) \hat{H} ( k ) [ \frac{{E}_{r 1}^{n} ( k )}{{E}_{r 2}^{n} ( k )} ] \qquad ( 12 )$$

where \tilde{X}₁(k) is the estimated transmitted signal from one of the users 2 of group 1 over a carrier k and \tilde{X}₂(k) is the estimated transmitted signal from the corresponding user 2 in group 2 that is using the same carrier k, n_{T} is the number of transmit antennas and SNR is a signal-to-noise ratio.

The symbols estimated from the first parallel processing branch for group 1 and the symbols estimated from the second parallel processing branch for group 2 can be applied to subsequent demapping, depuncturing and decoding processes in a processing block 40.

In a simplified implementation of this embodiment of the invention, it is possible for the interference canceller 32 to cancel the interference in only one of the groups (i.e. only one of the processing branches needs to be implemented), and the remaining interference can be dealt with during the equalisation process.

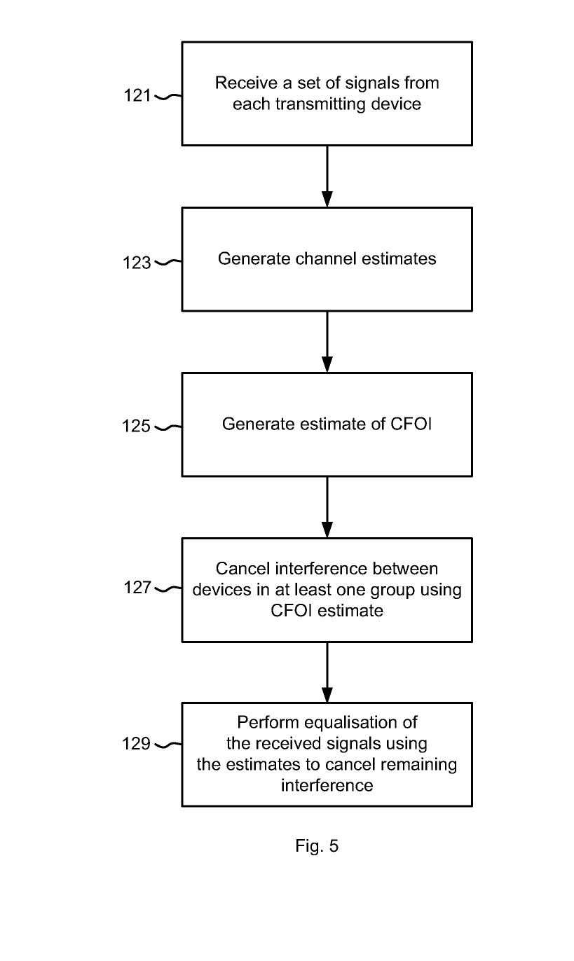

A method of receiving a data transmission in accordance with this embodiment of the invention is shown in FIG. 5. In step 121, the first (receiving) device 10 receives a respective set of signals from each of the second (transmitting) devices 2. Each of the signals has been transmitted from the second devices 2 using a carrier frequency offset determined from signals previously received from the first device 2 and a frequency carrier selected from a set of frequency carriers (which are orthogonal).

The first device 10 generates an estimate of the channels over which the signals have been transmitted (step 123).

As there will be interference between the transmissions from the second devices 2 caused by errors in the estimation of the frequency offset in the opposite link (i.e. from the first device 10 to the second devices 2), the first device 10 generates an estimate of the interference in the received signals caused by errors in the carrier frequency offsets estimated by each second device 2 (step 125).

In step 127, the interference from the errors in the carrier frequency offsets are cancelled for each of the second devices 2 within individual groups using the estimate of the CFOI.

In step 129, the first device equalises the output of step 127 using the determined estimates to remove the remaining interference and to generate an output stream of data symbols.

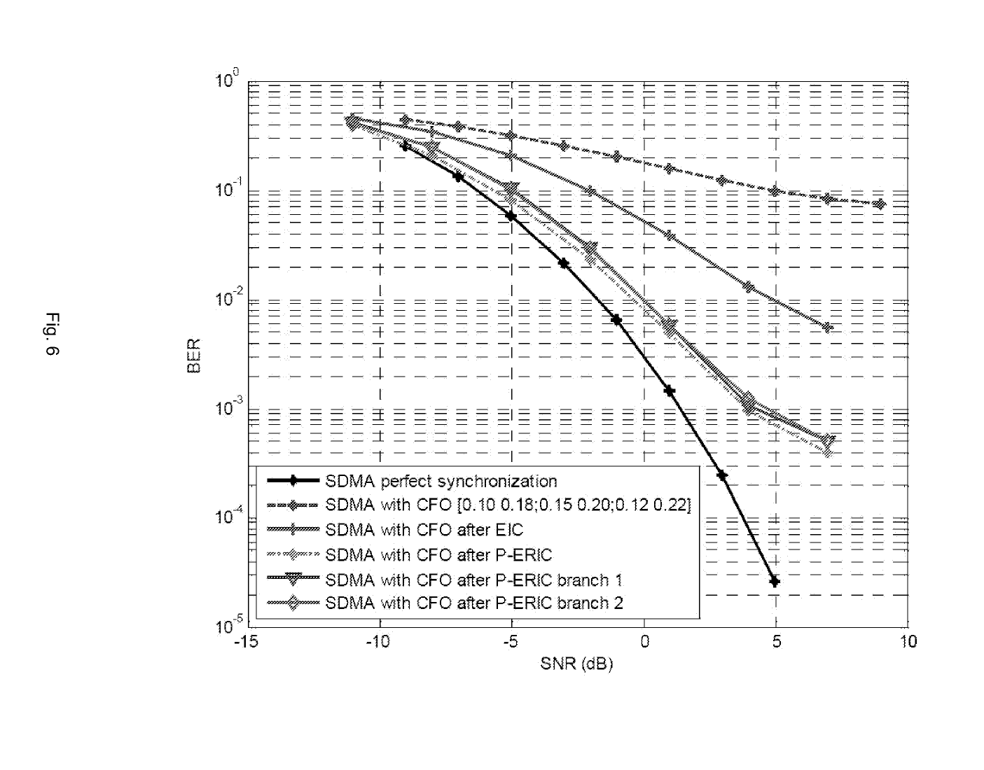

FIG. 6 shows the performance of both embodiments (equalisation with interference cancellation (EIC) and partial interference cancellation and residual interference cancellation with equalisation (P-EIC)) of the invention in relation to perfect synchronisation (i.e. where there are no errors in the carrier frequency offsets), and where there is no synchronisation. Clearly, both embodiments provide an improvement in the performance of the first device (measured in terms of the bit error rate (BER)) over no synchronisation, and the second embodiment (partial interference cancellation) provides enhanced performance over the first embodiment.

It will be appreciated that although the first devices 10 and 30 are shown as having two antennas 12, the invention can be applied to receiver architectures that include more than two antennas, and in particular architectures in which there are M antennas, where M is an integer greater than one. In this respect, it will be appreciated that the equations defined above are relevant to the two antenna embodiment, and are therefore included for illustrative purposes only.

It will also be appreciated that the invention can be applied to the cancellation or compensation of carrier frequency offset interference in communication systems other than OFDM, OFDMA and SDMA-OFDMA communication systems.

While the invention has been illustrated and described in detail in the drawings and foregoing description, such illustration and description are to be considered illustrative or exemplary and not restrictive; the invention is not limited to the disclosed embodiments.

Variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A first device for use in a communication system, the communication system further comprising a plurality of second devices, the system having a plurality of orthogonal frequency carriers available for transmissions, each second device having a respective carrier frequency offset estimated from signals received from the first device, each of the second devices transmitting a respective stream of symbols using the respective estimated carrier frequency offset and one or more frequency carriers selected from the plurality of orthogonal frequency carriers, the first device comprising:
receiver circuitry configured to receive respective signals from each of the second devices;
a channel estimator configured to generate, from the received signals, an estimate of the channel over which the signals have been transmitted;
an interference estimator configured to, from the received signals, an estimate of interference at the first device caused by errors in the carrier frequency offsets estimated by each second device; and
circuitry configured to equalise the received signals using the estimate of the channel and the estimate of the interference.

2. A first device as claimed in claim 1, further comprising a plurality of antennas connected to the receiver circuitry, each antenna receiving a respective set of signals from each of the second devices.

3. A first device as claimed in claim 1, further comprising a combiner that receives the estimate of the channel and the estimate of the interference, and provides a combined estimate to the circuitry for equalising the received signals.

4. A first device as claimed in claim 1, wherein the plurality of second devices are divided into a plurality of groups, and the interference estimator is configured to generate a respective estimate of the interference for each group of second devices.

5. A first device as claimed in claim 4, the first device further comprising:
circuitry configured to cancel interference at the first device using the estimate of the interference for each group, the circuitry being adapted to cancel the interference between second devices within at least one of the groups.

6. A first device as claimed in claim 5, wherein the circuitry for cancelling interference comprises a respective parallel processing branch associated with each of the groups of second devices, and wherein each parallel processing branch operates on the received signals to cancel the interference between second devices within the associated group using the output of the interference estimator.

7. A first device as claimed in claim 6, wherein the circuitry for equalising the received signals is adapted to receive the output of each parallel processing branch in the circuitry for cancelling interference, and to cancel the remaining interference from said outputs using the estimate of the channel and the estimate of the interference.

8. A first device as claimed in claim 5, wherein the circuitry for cancelling interference comprises a processing branch for one of the groups of second devices, and wherein the processing branch operates on the received signals to cancel the interference between second devices within said group using the output of the interference estimator.

9. A first device as claimed in claim 8, wherein the circuitry for equalising the received signals is adapted to receive the output of the processing branch in the circuitry for cancelling interference, and to cancel the remaining interference from said output using the estimate of the channel and the estimate of the interference.

10. A first device as claimed in claim 1, wherein the communication system is an orthogonal frequency division multiple access (OFDMA) communication system, a spatial division multiple access (SDMA) OFDMA communication system, or a multiple-input multiple-output (MIMO) communication system.

11. A method for operating a first device in a communication system, the system further comprising a plurality of second devices, the system having a plurality of orthogonal frequency carriers available for transmissions, each second device having a respective carrier frequency offset estimated from signals received from the first device, each of the second devices transmitting a respective stream of symbols using the respective estimated carrier frequency offset and one or more frequency carriers selected from the plurality of orthogonal frequency carriers, the method in the first device comprising:
receiving respective signals from each of the second devices;
generating, from the received signals, an estimate of the channel over which the signals have been transmitted;
generating, from the received signals, an estimate of interference at the first device caused by errors in the carrier frequency offsets estimated by each second device; and
equalising the received signals using the estimate of the channel and the estimate of the interference.

12. A method as claimed in claim 11, further comprising the step of combining the estimate of the channel and the estimate of the interference, and using the combined estimate in the step of equalising.

13. A method as claimed in claim 11, wherein the plurality of second devices are divided into a plurality of groups, and the step of generating an estimate of interference comprises generating a respective estimate of the interference for each group of second devices.

14. A method as claimed in claim 13, the method further comprising the step of:
cancelling interference at the first device between second devices within at least one of the groups; and
wherein the step of equalising the received signals comprises cancelling the remaining interference in the output of the step of cancelling interference.

15. A method as claimed in claim 14, wherein the step of cancelling interference comprises, for each group, cancelling the interference in the received signals between second devices within each of the groups using the estimates of the interference.

16. A method as claimed in claim 15, wherein the step of equalising the received signals uses the output for each group from the step of cancelling interference, and cancels the remaining interference from said outputs using the estimate of the channel and the estimates of the interference.

17. A method as claimed in claim 11, wherein the communication system is an orthogonal frequency division multiple access (OFDMA) communication system, a spatial division multiple access (SDMA) OFDMA communication system, or a multiple-input multiple-output (MIMO) communication system.
